(19) United States
(12) Patent Application Publication
(10) Pub. No.: US 2026/0021868 A1
(43) Pub. Date: Jan. 22, 2026

(54) Reversible Drop Case Assemblies for Snowmobiles

(71) Applicant: Arctic Cat Inc., Thief River Falls, MN (US)

(72) Inventors: Samuel James Sandoz, Thief River Falls, MN (US); Donald Dean Carr, Thief River Falls, MN (US)

(73) Assignee: Arctic Cat Inc., Thief River Falls, MN (US)

(21) Appl. No.: 18/780,261

(22) Filed: Jul. 22, 2024

(51) Int. Cl. B62M 27/02; F16H 63/30

(52) U.S. Cl. CPC B62M 27/02; F16H 63/302; F16H 2312/09

(57) ABSTRACT

A powertrain for a snowmobile includes an engine, a gearbox input shaft and a drop case assembly receiving rotational energy from the gearbox input shaft. The drop case assembly is switchable between a forward mode and a reverse mode and includes an input gear assembly coupled to the gearbox input shaft. The input gear assembly includes a forward input pulley rotatably coupled to the gearbox input shaft, a reverse input gear rotatably coupled to the gearbox input shaft and an input selector collar between the forward input pulley and the reverse input gear. The input selector collar is slidable between a forward mode position engaged with the forward input pulley to transfer rotational energy from the gearbox input shaft to the forward input pulley and a reverse mode position engaged with the reverse input gear to transfer rotational energy from the gearbox input shaft to the reverse input gear.

### TECHNICAL FIELD OF THE DISCLOSURE

The present disclosure relates, in general, to drivetrains for use in land vehicles such as snowmobiles and, in particular, to reversible drop case assemblies including an input gear assembly with an input selector collar translatable between a forward input pulley and a reverse input gear to switch between a forward geartrain in a forward mode and a reverse geartrain in a reverse mode.

### BACKGROUND

Snowmobiles are popular land vehicles used for transportation and recreation in cold and snowy conditions. Certain snowmobiles are designed for specific applications such as trail, utility, mountain, race and crossover applications, to name a few. Snowmobiles typically include a frame assembly, or chassis, that supports various components of the snowmobile such as an engine, a transmission, a steering system and a ground-engaging endless drive track disposed in a longitudinally extending tunnel. The engine and transmission power the drive track to enable ground propulsion for the vehicle. A rider controls the operation of the snowmobile using the steering system including a handlebar assembly that is operatively linked to a pair of ski assemblies that provides flotation for the front end of the snowmobile over snow.

Many modern snowmobiles are equipped with reverse capability to allow the snowmobile to perform certain operations or maneuvers including backing out of a driveway or reversing out of an obstacle such as a snow drift or ditch. Some types of engines such as certain two-stroke engines are reversible and therefore capable of propelling a snowmobile in both the forward and reverse directions without the need for additional gearing. Other types of engines such as certain four-stroke engines, however, are operable in only a single direction and therefore require additional gearing to enable reverse capability for the snowmobile. Snowmobiles may utilize a drop case, sometimes referred to as a chain case, belt drive housing or belt drive assembly, to transfer rotational energy from the engine or transmission to a track driveshaft that rotates the drive track. Drop cases may house switchable gearing to form either a forward or reverse geartrain, thus rotating the track driveshaft in either the forward or reverse rotational directions, respectively. Current drop cases, however, are often bulky and encroach upon adjacent components such as the footrests or toe stops of the snowmobile, necessitating an expensive and time-consuming redesign, resizing or retooling of such components. Other types of drop cases may rely upon complex and intricate designs in order to switch between the forward and reverse modes, increasing the risk of operational failure. Accordingly, a need has arisen for reversible drop cases with a reliable design and an enhanced form factor that does not impinge upon adjacent components of the vehicle.

### SUMMARY

In a first aspect, the present disclosure is directed to a powertrain for a snowmobile. The powertrain includes an engine, a gearbox input shaft receiving rotational energy from the engine and a drop case assembly receiving rotational energy from the gearbox input shaft. The drop case assembly is switchable between a forward mode and a reverse mode and includes an input gear assembly coupled to the gearbox input shaft to define a common input axis therewith. The input gear assembly includes a forward input pulley rotatably coupled to the gearbox input shaft, a reverse input gear rotatably coupled to the gearbox input shaft and an input selector collar at least partially interposed between the forward input pulley and the reverse input gear. The input selector collar is slidable along the common input axis between various positions including a forward mode position engaged with the forward input pulley to transfer rotational energy from the gearbox input shaft to the forward input pulley in the forward mode and a reverse mode position engaged with the reverse input gear to transfer rotational energy from the gearbox input shaft to the reverse input gear in the reverse mode.

In some embodiments, the input gear assembly may include a spacer defining an inner spline and an outer spline, the spacer forming a splined connection with the gearbox input shaft via the inner spline of the spacer. In such embodiments, the input selector collar may form a slidable splined connection with the spacer via the outer spline of the spacer. In certain embodiments, the input selector collar may bridge the spacer and the forward input pulley in the forward mode position and may bridge the spacer and the reverse input gear in the reverse mode position. In some embodiments, the forward input pulley may have an input selector collar-facing side defining a collar receiving spline configured to engage the input selector collar in the forward mode position. In certain embodiments, the reverse input gear may have an input selector collar-facing side defining a collar receiving spline configured to engage the input selector collar in the reverse mode position. In some embodiments, the various positions of the input selector collar may include a neutral position between the forward mode position and the reverse mode position, the input selector collar disengaged from the forward input pulley and the reverse input gear in the neutral position.

In certain embodiments, the drop case assembly may have an idler assembly including a post and a reversible idler shaft rotatably coupled to the post. In such embodiments, the idler shaft may reversibly rotate in a first rotational direction and a second rotational direction opposite of the first rotational direction responsive to the position of the input selector collar. In some embodiments, the idler assembly may include a forward mode pulley coupled to the forward input pulley of the input gear assembly via a chain such that the idler shaft and the forward input pulley rotate in the same rotational direction synchronously, the idler shaft rotating in the first rotational direction responsive to the input selector collar in the forward mode position. In certain embodiments, the idler shaft may include a reverse mode gear meshed with the reverse input gear of the input gear assembly such that the idler shaft and the reverse mode gear rotate in opposite rotational directions synchronously, the idler shaft rotating in the second rotational direction responsive to the input selector collar in the reverse mode position. In some embodiments, the idler assembly may include an idler output pulley. In such embodiments, the drop case assembly may include a reversible output pulley coupled to the idler output pulley via an output chain such that the output pulley and the idler shaft rotate in the same rotational direction synchronously, the output pulley reversibly rotatable in a first rotational direction and a second rotational direction opposite of the first rotational direction responsive to the position of the input selector collar. In certain embodiments, the powertrain may include a track driveshaft, the output pulley coupled to the track driveshaft to define a common output axis therewith. In some embodiments, the output pulley may be coupled to the input gear assembly via the idler shaft. In certain embodiments, the input gear assembly may be positioned above the output pulley and the idler assembly may be interposed between the input gear assembly and the output pulley.

In some embodiments, in the forward mode position of the input selector collar, the drop case assembly may form a forward geartrain including components in the following sequence: (1) the input selector collar, (2) the forward input pulley, (3) the idler shaft then (4) the output pulley. In certain embodiments, in the forward mode position of the input selector collar, the gearbox input shaft, the input selector collar, the forward input pulley, the idler shaft and the output pulley may rotate in the same rotational direction synchronously to move the snowmobile in a forward direction. In some embodiments, in the reverse mode position of the input selector collar, the drop case assembly may form a reverse geartrain including components in the following sequence: (1) the input selector collar, (2) the reverse input gear, (3) the idler shaft then (4) the output pulley. In certain embodiments, in the reverse mode position of the input selector collar, the gearbox input shaft, the input selector collar and the reverse input gear may rotate in a first rotational direction synchronously and the idler shaft and the output pulley may rotate in a second rotational direction synchronously to move the snowmobile in a reverse direction, the first rotational direction opposite of the second rotational direction.

In a second aspect, the present disclosure is directed to a snowmobile including a frame assembly and a powertrain coupled to the frame assembly. The powertrain includes an engine, a gearbox input shaft receiving rotational energy from the engine and a drop case assembly receiving rotational energy from the gearbox input shaft. The drop case assembly is switchable between a forward mode and a reverse mode and includes an input gear assembly coupled to the gearbox input shaft to define a common input axis therewith. The input gear assembly includes a forward input pulley rotatably coupled to the gearbox input shaft, a reverse input gear rotatably coupled to the gearbox input shaft and an input selector collar at least partially interposed between the forward input pulley and the reverse input gear. The input selector collar is slidable along the common input axis between various positions including a forward mode position engaged with the forward input pulley to transfer rotational energy from the gearbox input shaft to the forward input pulley in the forward mode and a reverse mode position engaged with the reverse input gear to transfer rotational energy from the gearbox input shaft to the reverse input gear in the reverse mode.

In some embodiments, the reverse input gear may be inboard of the forward input pulley and the reverse mode position of the input selector collar may be inboard of the forward mode position of the input selector collar. In certain embodiments, the drop case assembly may include an actuator assembly including a shift fork coupled to the input selector collar. In such embodiments, the actuator assembly may slide the input selector collar along the common input axis between various positions. In certain embodiments, the input selector collar may have an outer surface defining first and second positioning ridges. In such embodiments, the shift fork may include one or more tines interposed between the first and second positioning ridges.

### BRIEF DESCRIPTION OF THE DRAWINGS

For a more complete understanding of the features and advantages of the present disclosure, reference is now made to the detailed description along with the accompanying figures in which corresponding numerals in the different figures refer to corresponding parts and in which:

FIGS. 1A-1C are schematic illustrations of a snowmobile including a reversible drop case assembly in accordance with embodiments of the present disclosure;

FIGS. 2A-2C are various views of a snowmobile drivetrain including a reversible drop case assembly in accordance with embodiments of the present disclosure;

FIG. 3 is an isometric view of a drop case assembly coupled to a frame assembly of a snowmobile in accordance with embodiments of the present disclosure;

FIGS. 4A-4C are various views of a gearbox used in previous snowmobiles to provide reverse capability;

FIGS. 5A-5C are various views of a drop case assembly for a snowmobile in accordance with embodiments of the present disclosure;

FIGS. 6A-6B are various views of an input selector collar for a drop case assembly in accordance with embodiments of the present disclosure;

FIG. 7 is a cross-sectional view of an idler assembly for a drop case assembly in accordance with embodiments of the present disclosure;

FIGS. 8A-8B are various views of an actuator assembly for a drop case assembly in accordance with embodiments of the present disclosure; and

FIGS. 9A-9B are various views of an input gear assembly for a drop case assembly in which an input selector collar is shown in forward mode and reverse mode positions in accordance with embodiments of the present disclosure.

### DETAILED DESCRIPTION

While the making and using of various embodiments of the present disclosure are discussed in detail below, it should be appreciated that the present disclosure provides many applicable inventive concepts, which can be embodied in a wide variety of specific contexts. The specific embodiments discussed herein are merely illustrative and do not delimit the scope of the present disclosure. In the interest of clarity, all features of an actual implementation may not be described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present disclosure, the devices, members, apparatuses, and the like described herein may be positioned in any desired orientation. Thus, the use of terms such as “above,” “below,” “upper,” “lower” or other like terms to describe a spatial relationship between various components or to describe the spatial orientation of aspects of such components should be understood to describe a relative relationship between the components or a spatial orientation of aspects of such components, respectively, as the devices described herein may be oriented in any desired direction. As used herein, the term “coupled” may include direct or indirect coupling by any means, including by mere contact or by moving and/or non-moving mechanical connections.

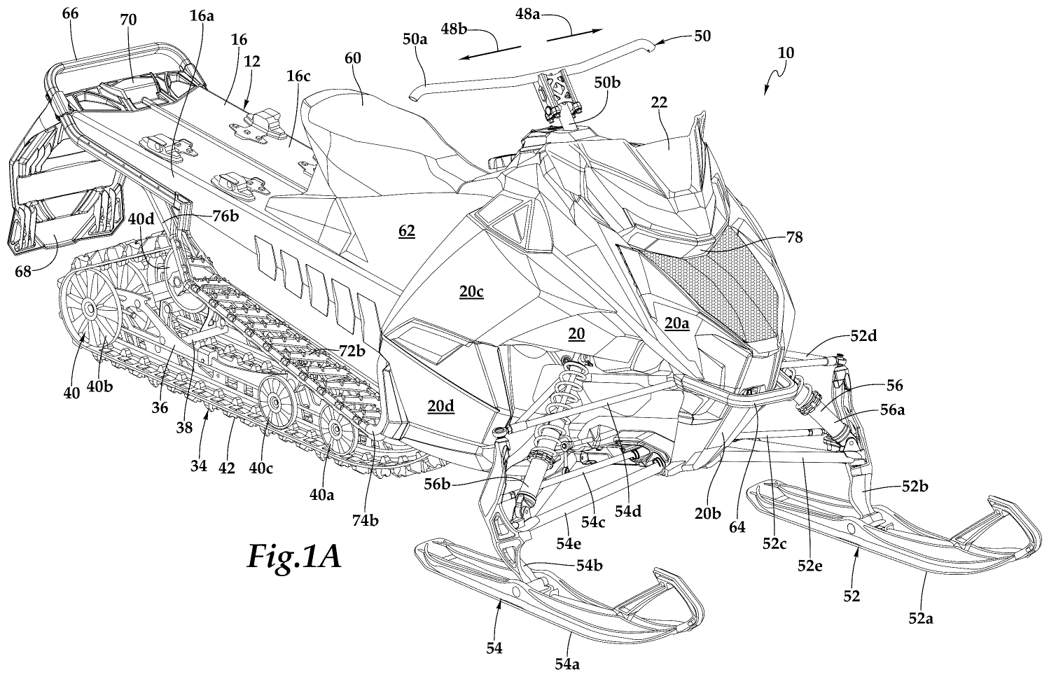

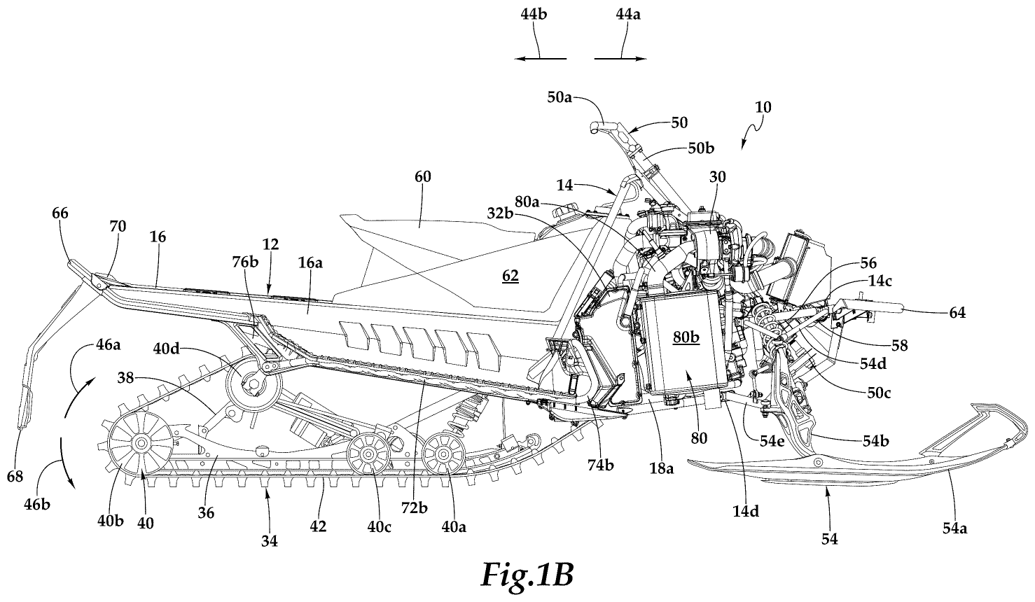

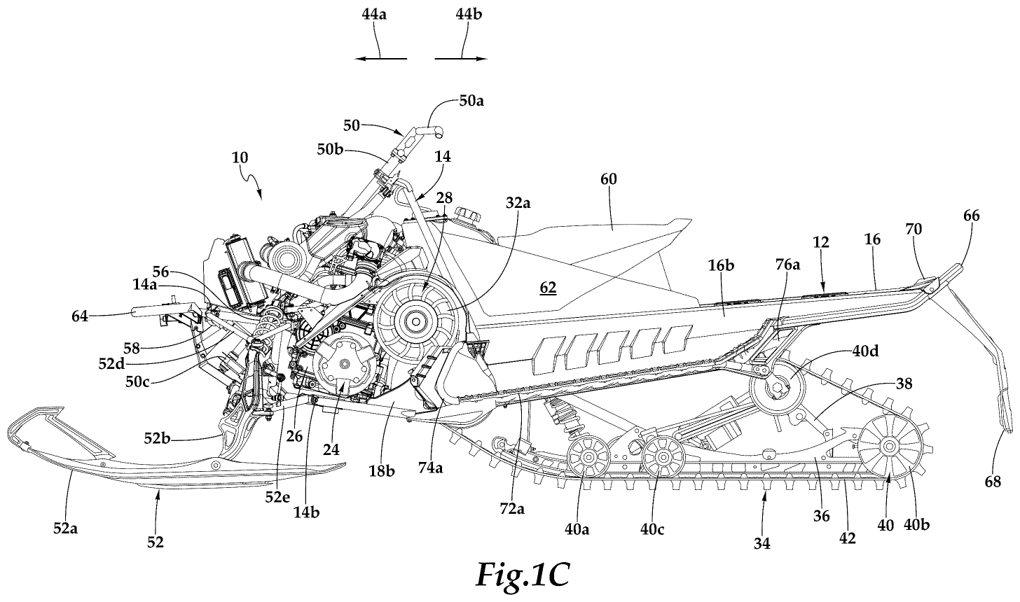

Referring to FIGS. 1A-1C in the drawings, a land vehicle depicted as a snowmobile is schematically illustrated and generally designated 10. Structural support for snowmobile 10 is provided by a chassis 12 that includes a forward frame assembly 14 and a longitudinally extending tunnel 16. Forward frame assembly 14 may be formed from interconnected tubular members such as round and hollow tubular members comprised of metal, metal alloy, polymeric materials, fiber reinforced polymer composites and/or combinations thereof that are coupled together by welds, bolts, pins or other suitable fastening means. A right side plate member 18a and a left side plate member 18b are coupled to and preferably welded to forward frame assembly 14 such that forward frame assembly 14 and plate members 18a, 18b form a welded frame assembly. Tunnel 16 is coupled to forward frame assembly 14 and plate members 18a, 18b with welds, bolts, rivets or other suitable means. In the illustrated embodiment, tunnel 16 includes a right sidewall 16a, a left sidewall 16b and a top panel 16c. Tunnel 16 may be integrally formed or may consist of multiple members that are coupled together with welds, bolts, rivets or other suitable means. Plate members 18a, 18b and tunnel 16 may be formed from sheet metal, metal alloy, fiber reinforced polymer or other suitable material or combination of materials.

Various components of snowmobile 10 are assembled on or around forward frame assembly 14. One or more body panels 20 cover and protect the various components of snowmobile 10 including parts of forward frame assembly 14. For example, hood panels 20a, a nose panel 20b, an upper right side panel 20c and a lower right side panel 20d shield underlying componentry from snow and terrain. Similarly, an upper left side panel and a lower left side panel (not visible) also shield underlying componentry from snow and terrain. In the illustrated embodiment, snowmobile 10 has a windshield 22 that shields the rider of snowmobile 10 from snow, terrain and frigid air during operation. Even through snowmobile 10 has been described and depicted as including specific body panels 20, it should be understood by those having ordinary skill in the art that a snowmobile of the present disclosure may include any number of body panels in any configuration to provide shielding functionality.

Body panels 20 have been removed from snowmobile 10 in FIGS. 1B-1C to reveal the underlying components of snowmobile 10. For example, snowmobile 10 has a powertrain 24 that includes an engine 26 and a drivetrain 28, both of which are coupled to forward frame assembly 14. Engine 26 resides in an engine bay formed within forward frame assembly 14. Engine 26 may be any type of engine such as a four-stroke engine, a two-stroke engine, a rotary engine, an electric motor or other prime mover. In the illustrated embodiment, engine 26 is a forced induction internal combustion engine that receives boost from a turbocharger 30. In other embodiments, engine 26 may operate as a naturally aspirated internal combustion engine. Engine 26 converts thermal energy into mechanical energy to drive the moving parts of snowmobile 10, thereby enabling motion.

In the illustrated embodiment, drivetrain 28 includes a transmission depicted as a continuously variable transmission 32a that varies the ratio of the engine output speed to the drive track input speed. In other embodiments, the transmission for snowmobile 10 may be an electrically variable transmission or other suitable transmission type. A drive track system 34 is at least partially disposed within and/or below tunnel 16 and is in contact with the ground to provide ground propulsion for snowmobile 10. Torque and rotational energy are provided to drive track system 34 from powertrain 24. Drive track system 34 includes a track frame 36 and a rear suspension assembly 38 that is coupled to tunnel 16. A plurality of idler wheel assemblies 40 are rotatably coupled to track frame 36 and rear suspension assembly 38 including a forwardmost idler wheel assembly 40a, an aftmost idler wheel assembly 40b, an intermediate idler wheel assembly 40c and an uppermost idler wheel assembly 40d. Drive track system 34 also includes a ground-engaging endless drive track 42 that is driven by a track drive sprocket via a track driveshaft (not visible) that is rotated responsive to torque provided from powertrain 24. The track drive sprocket is considered to be a component of powertrain 24 as well as a component of drive track system 34. Drivetrain 28 includes a reversible drop case assembly 32b that receives rotational energy from engine 26 via continuously variable transmission 32a and transfers the rotational energy to the track driveshaft to rotate drive track 42 via the track drive sprocket.

Drive track 42 rotates around idler wheel assemblies 40 of track frame 36 and rear suspension assembly 38 to propel snowmobile 10 in either the forward direction, as indicated by arrow 44a, or the backward direction, as indicated by arrow 44b. When viewed from the right side of snowmobile 10, as best seen in FIG. 1, drive track 42 rotates around idler wheel assemblies 40 of track frame 36 and rear suspension assembly 38 in a clockwise direction, as indicated by arrow 46a, to propel snowmobile 10 in the forward direction 44a and in a counterclockwise direction, as indicated by arrow 46b, to propel snowmobile 10 in the backward direction 44b. The backward direction may also be referred to herein as the aftward direction. The forward and backward directions also represent the longitudinal direction of snowmobile 10 with the lateral direction of snowmobile 10 being normal thereto and represented by the leftward direction, as indicated by arrow 48a, and the rightward direction, as indicated by arrow 48b. It should be understood by those having ordinary skill in the art that the left side and the right side of snowmobile 10 will be with reference to a rider of snowmobile 10 with the left side of snowmobile 10 corresponding to the left side of the rider and the right side of snowmobile 10 corresponding to the right side of the rider.

Snowmobile 10 has a steering system 50 that includes a handlebar assembly 50a that is operably coupled to a left ski assembly 52 and a right ski assembly 54 by a steering column 50b and a steering arm assembly 50c. Left ski assembly 52 includes a ski 52a, a spindle 52b, a tie rod 52c, an upper A-arm 52d and a lower A-arm 52e. Right ski assembly 54 includes a ski 54a, a spindle 54b, a tie rod 54c, an upper A-arm 54d and a lower A-arm 54e. Left ski assembly 52 is pivotably coupled to forward frame assembly 14 by upper A-arm 52d and lower A-arm 52e. Likewise, right ski assembly 54 is pivotably coupled to forward frame assembly 14 by upper A-arm 54d and lower A-arm 54e. More specifically, upper A-arm 52d couples left ski assembly 52 to forward frame assembly 14 at upper A-arm mounts 14a. Lower A-arm 52e couples left ski assembly 52 to forward frame assembly 14 at lower A-arm mounts 14b. Upper A-arm 54d couples right ski assembly 54 to forward frame assembly 14 at upper A-arm mounts 14c. Lower A-arm 54e couples right ski assembly 54 to forward frame assembly 14 at lower A-arm mounts 14d. Left ski assembly 52 and right ski assembly 54 may be collectively referred to herein as a ski system.

Snowmobile 10 has a front suspension assembly 56 that is coupled between each of ski assemblies 52, 54 and forward frame assembly 14 to provide front end support for snowmobile 10. More specifically, a left shock absorber 56a couples left ski assembly 52 to forward frame assembly 14 and a right shock absorber 56b couples right ski assembly 54 to forward frame assembly 14. Steering system 50 enables the rider to steer snowmobile 10 by rotating handlebar assembly 50a which causes skis 52a, 54a to pivot. In the illustrated embodiment, the pivoting of skis 52a, 54a responsive to rotation of handlebar assembly 50a is assisted by an electric power steering system (EPS) depicted as electronic steering assist unit 58.

The rider controls snowmobile 10 from a seat 60 that is positioned atop a fuel tank 62, above tunnel 16, aft of handlebar assembly 50a and aft of forward frame assembly 14. Snowmobile 10 has a front bumper 64 that is coupled to forward frame assembly 14. Snowmobile 10 has an aft bumper 66 that is coupled to an aft end of tunnel 16 and includes a cross member positioned aft of tunnel 16 to allow a person to lift the rear end of snowmobile 10 in the event that snowmobile 10 becomes stuck or needs to be repositioned when it is not moving. A snow flap 68 is coupled to aft bumper 66 and is configured to deflect snow emitted by drive track 42. A taillight housing 70 is coupled between aft bumper 66 and the aft end of tunnel 16 and is configured to house a taillight of snowmobile 10. Snowmobile 10 includes a left side running board assembly 72a and a right side running board assembly 72b. At its forward end, running board assembly 72a is coupled to forward frame assembly 14 by an attachment rail 74a, which partially defines a toe stop to protect the left foot of the rider. In addition, running board assembly 72a is coupled to tunnel 16 via a left side tunnel bracket 76a. At its forward end, running board assembly 72b is coupled to forward frame assembly 14 by an attachment rail 74b, which partially defines a toe stop to protect the right foot of the rider. In addition, running board assembly 72b is coupled to tunnel 16 via a right side tunnel bracket 76b. Snowmobile 10 includes a headlight assembly 78. Snowmobile 10 has an exhaust system 80 that includes an exhaust manifold that is coupled to one or more exhaust outlets on engine 26, an exhaust duct 80a and a muffler 80b. As exhaust system 80 including the exhaust manifold is coupled to the forward side of engine 26, the forward side of engine 26 may be referred to as the hot side of engine 26 due to the hot temperatures associated with engine exhaust. The aftward side of engine 26 is concomitantly considered the cool side of engine 26 as hot exhaust system components are located opposite and/or remote therefrom.

It should be appreciated that snowmobile 10 is merely illustrative of a variety of vehicles that can implement the embodiments disclosed herein. Indeed, drop case assembly 32b may be implemented on any ground-based vehicle. Other vehicle implementations can include motorcycles, snow bikes, all-terrain vehicles (ATVs), utility vehicles, recreational vehicles, scooters, automobiles, mopeds, jet skis, straddle-type vehicles and the like. As such, those skilled in the art will recognize that drop case assembly 32b can be integrated into a variety of vehicle configurations. It should be appreciated that even though ground-based vehicles are particularly well-suited to implement the embodiments of the present disclosure, airborne vehicles and devices such as aircraft can also implement the embodiments.

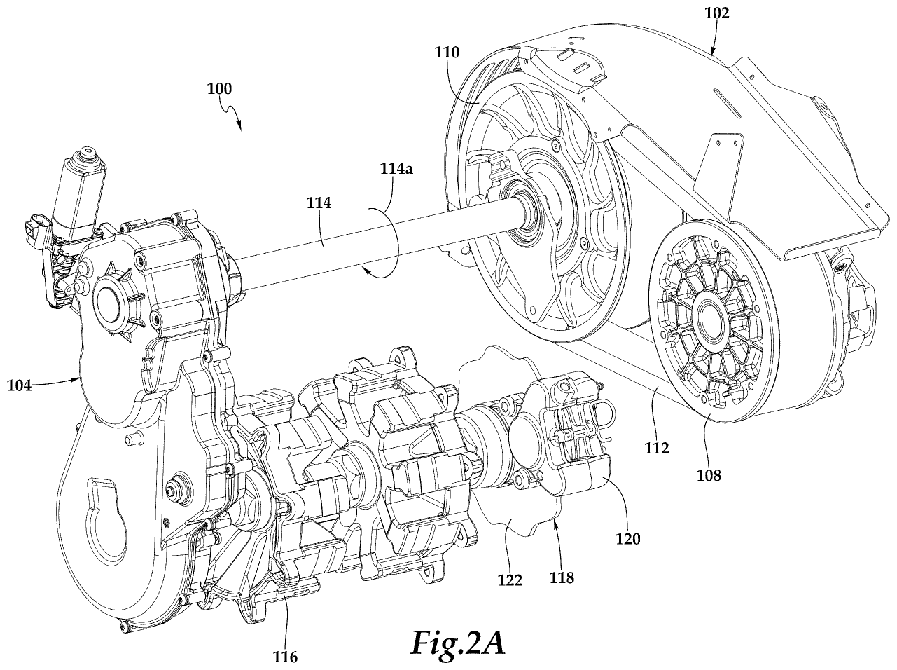

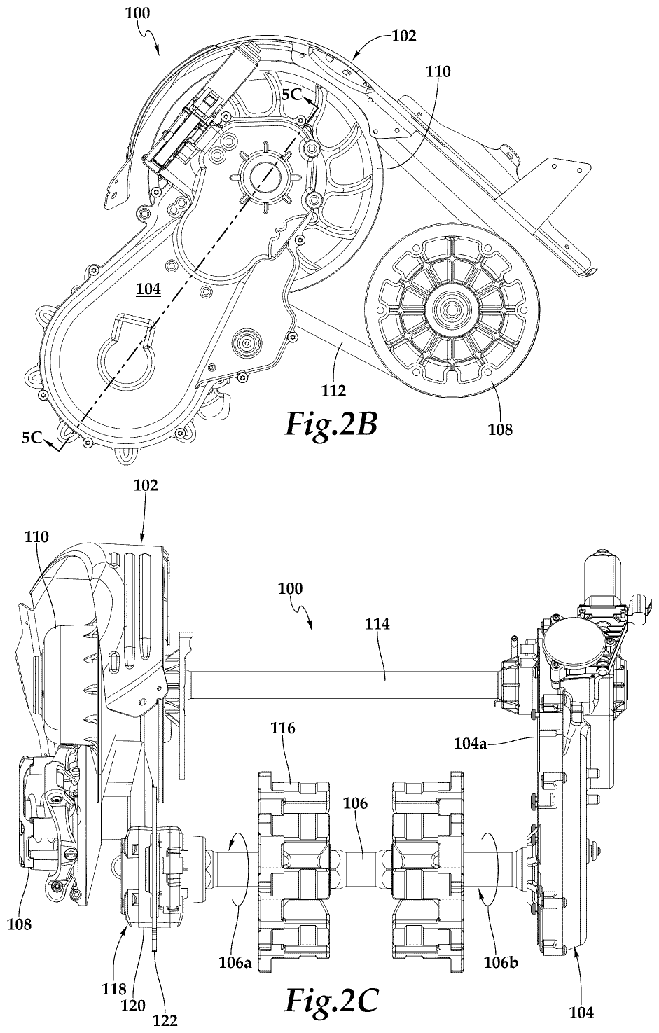

Referring to FIGS. 2A-2C in the drawings, drivetrain 28 in FIGS. 1A-1C is depicted in additional detail as drivetrain 100 including continuously variable transmission 102, drop case assembly 104 and track driveshaft 106. The output of engine 26 in FIGS. 1A-1C is received as rotational energy by a primary clutch 108 via a driveshaft (not shown). Primary clutch 108 is connected to a secondary clutch 110 by a belt 112 such as a V-belt to form continuously variable transmission 102, which transmits the rotational energy received from engine 26 to a gearbox input shaft, or jack shaft, 114. Primary clutch 108 and secondary clutch 110 each include a stationary sheave and a moveable sheave with belt 112 pinched therebetween. As the speed of engine 26 increases or decreases, the moveable sheaves move toward or away from the stationary sheaves to selectively alter the effective gear ratio of continuously variable transmission 102. Drop case assembly 104 receives rotational energy from gearbox input shaft 114 and transfers the rotational energy to track driveshaft 106, thereby lowering the driveline of drivetrain 100 down to drive track system 34 in FIGS. 1A-1C to provide rotational energy thereto. Both gearbox input shaft 114 and track driveshaft 106 are rotatably coupled to the same inboard side 104a of drop case assembly 104. Drive track engagement sprockets 116 are fixedly coupled near the center of track driveshaft 106. Drive track engagement sprockets 116 engage cogs or other features on the inside of drive track 42 in FIGS. 1A-1C to provide rotational energy from track driveshaft 106 to drive track 42.

In some embodiments, engine 26 is a four-stroke engine and therefore rotates gearbox input shaft 114 in a single rotational direction 114a. Drop case assembly 104 is a reversible drop case assembly and may therefore convert the unidirectional rotation of gearbox input shaft 114 into bidirectional rotation of track driveshaft 106. More specifically, drop case assembly 104 may rotate track driveshaft 106 in either rotational direction 106a, corresponding to forward direction 44a of snowmobile 10, or rotational direction 106b, corresponding to backward direction 44b of snowmobile 10. Thus, track driveshaft 106 receives reversible rotational energy from engine 26 via continuously variable transmission 102 and drop case assembly 104. It should be appreciated that drop case assembly 104 is not limited to use with four-stroke engines, and may be used with two-stroke engines, rotary engines, electric motors or any other prime mover. A disc-and-caliper braking system 118 is located at the end of track driveshaft 106 opposite of drop case assembly 104. Braking system 118 includes a caliper assembly 120 and a brake rotor 122, both of which are coupled to track driveshaft 106. The brake pads of caliper assembly 120 press upon brake rotor 122 to slow or stop track driveshaft 106, thereby slowing or stopping snowmobile 10.

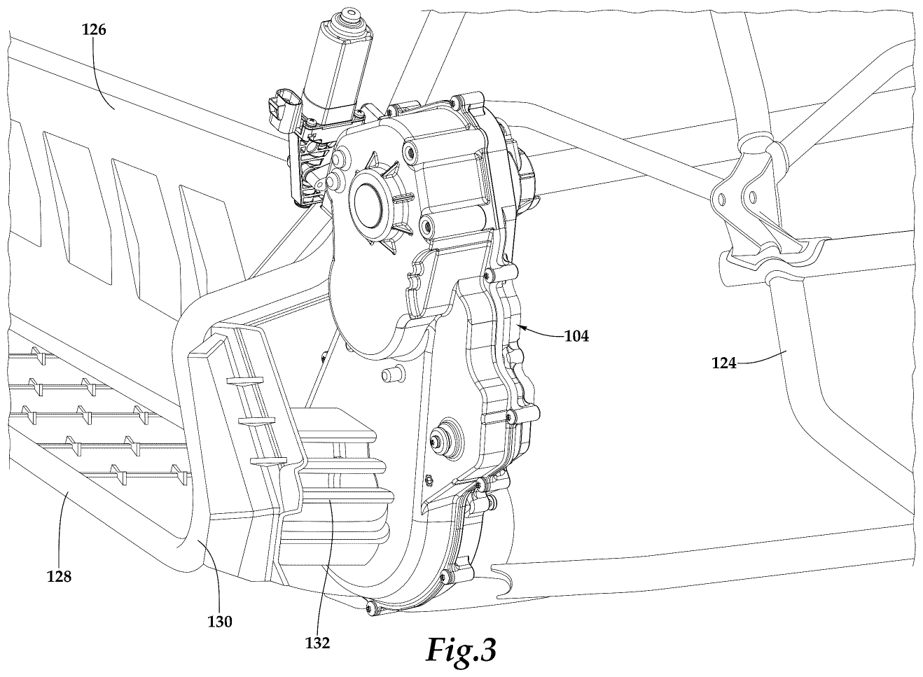

Referring additionally to FIG. 3 in the drawings, drop case assembly 104 is shown positioned relative to forward frame assembly 124, tunnel 126 and right running board assembly 128 of a snowmobile such as snowmobile 10 in FIGS. 1A-1C. The forward end of right running board assembly 128 includes attachment rail 130, which partially defines toe stop 132. The rider of snowmobile 10 places his or her right foot on right running board assembly 128 during operation. Toe stop 132 protects the right foot of the rider from oncoming debris and the moving parts of snowmobile 10. In some embodiments, drop case assembly 104 may be coupled to forward frame assembly 124, tunnel 126, right running board assembly 128, toe stop 132 and/or other portions of snowmobile 10 depicted in FIGS. 1A-1C. Currently-implemented drop cases are often bulky and encroach upon adjacent components such as the toe stops of the vehicle, necessitating an expensive and time-consuming redesign, resizing or retooling of such components. The bottom of drop case assembly 104 has a thinner form factor than previous drop cases to fit in the packaging space made available by toe stop 132, thereby lowering the production cost of snowmobile 10.

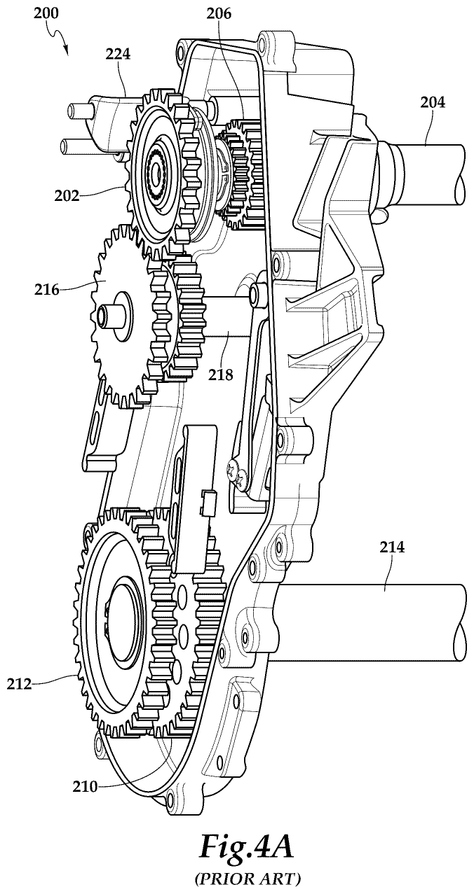

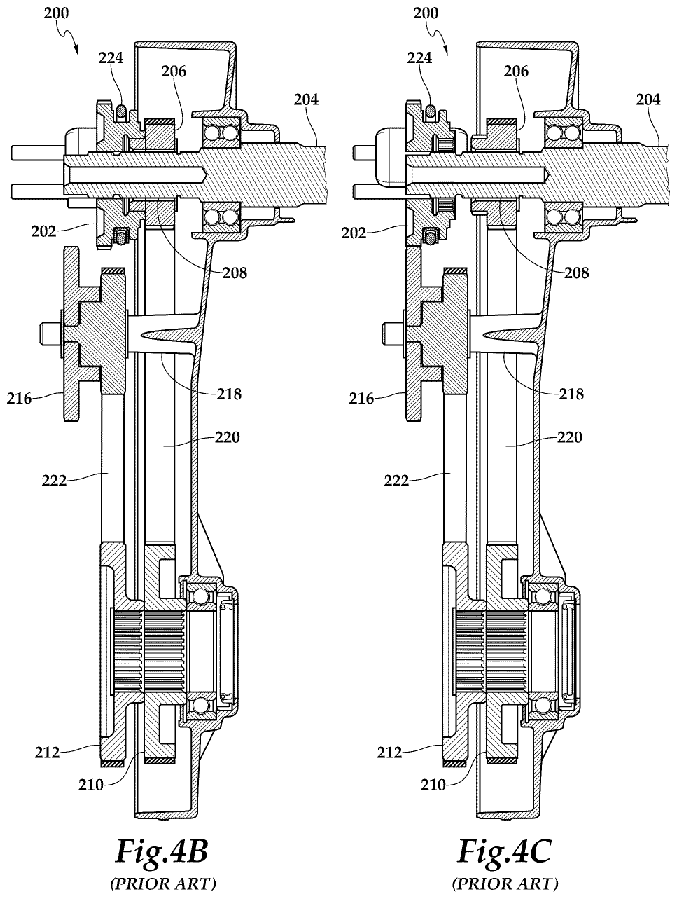

Referring to FIGS. 4A-4C in the drawings, a chain drive assembly used in previous snowmobiles is schematically illustrated and generally designated 200. Some types of engines such as certain two-stroke engines are reversible and therefore capable of propelling a snowmobile in both the forward and reverse directions without the need for additional gearing. Other types of engines such as certain four-stroke engines, however, are operable in only a single direction and therefore require additional gearing to enable reverse capability for the snowmobile. Chain drive assembly 200 is an example of such a gearing mechanism that enables a snowmobile to travel in reverse. Chain drive assembly 200 has a cover that is not shown to expose the components therein. FIG. 4B illustrates chain drive assembly 200 in a forward mode and FIGS. 4A and 4C illustrate chain drive assembly 200 in a reverse mode. Chain drive assembly 200 includes a top shiftable gear 202 that is splined to an input shaft 204 and a top forward gear 206 that is freely rotatable relative to input shaft 204 via a bearing 208. Chain drive assembly 200 also includes bottom forward and reverse gears 210, 212, both of which are splined to an output shaft 214. Output shaft 214 may be coupled to a ground-engaging component of the snowmobile such as a drive track. A top reverse gear 216 is rotatably coupled to an idler shaft 218. As shown in FIGS. 4B and 4C, top forward gear 206 and bottom forward gear 210 are interconnected by a forward drop chain 220 and top reverse gear 216 and bottom reverse gear 212 are interconnected by a reverse drop chain 222. Forward and reverse drop chains 220, 222 are not shown in FIG. 4A to expose underlying elements.

A shift fork 224 is coupled to top shiftable gear 202 and moves top shiftable gear 202 between the forward mode position shown in FIG. 4B and the reverse mode position shown in FIGS. 4A and 4C. When shift fork 224 moves top shiftable gear 202 into the forward mode position, top shiftable gear 202 comes into splined engagement with top forward gear 206 so that rotational energy from input shaft 204 is transferred to top forward gear 206 via top shiftable gear 202. Rotational energy is then transferred from top forward gear 206 to bottom forward gear 210 via forward drop chain 220 to rotate output shaft 214 in a direction that causes the vehicle to move forward. Conversely, when shift fork 224 moves top shiftable gear 202 into the reverse mode position, top shiftable gear 202 meshes with top reverse gear 216 to rotate top reverse gear 216 in the opposite direction as top shiftable gear 202. Rotational energy is then transferred from top reverse gear 216 to bottom reverse gear 212 via reverse chain 222 to rotate output shaft 214 in a direction that causes the vehicle to move backward. Previous snowmobiles have used these and similar chain-driven gear mechanisms, some of which require an enclosed housing filled with lubricating fluid to prevent wear, to reversibly transfer rotational energy from input shaft 204 to output shaft 214. Bottom forward and reverse gears 210, 212 are stacked as illustrated along the rotational axis of output shaft 214 to enable bidirectional rotation of output shaft 214. Additionally, chain drive assembly 200 requires two drop chains 220, 222 extending to bottom forward and reverse gears 210, 212, respectively. The need for two bottom forward and reverse gears 210, 212 and two drop chains 220, 222 widens the bottom portion of chain drive assembly 200 such that chain drive assembly 200 may be unable to fit in the packaging space allowed by other existing components of the vehicle such as the toe stop.

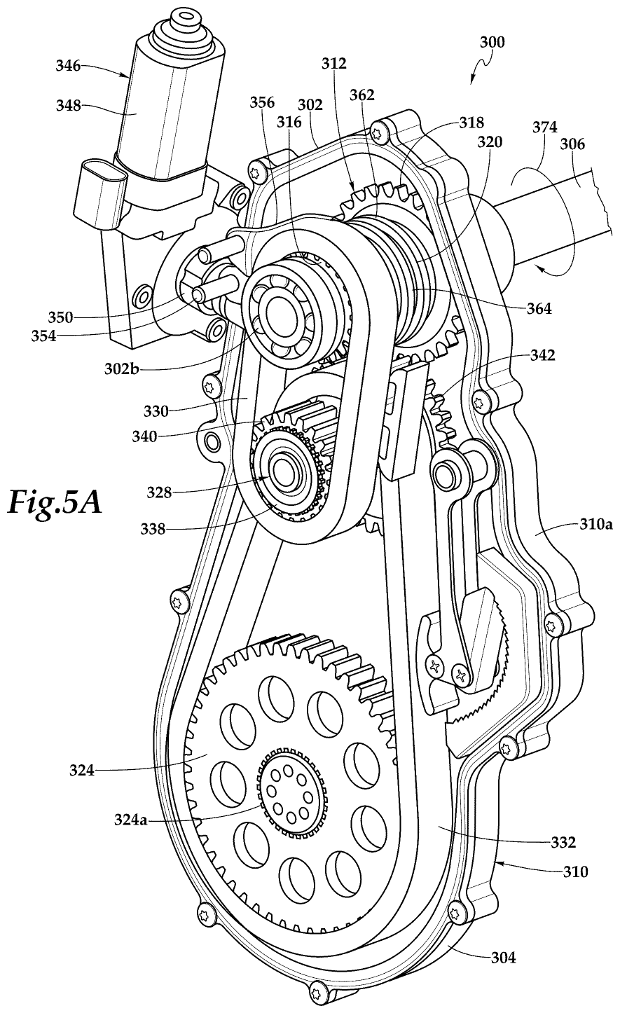

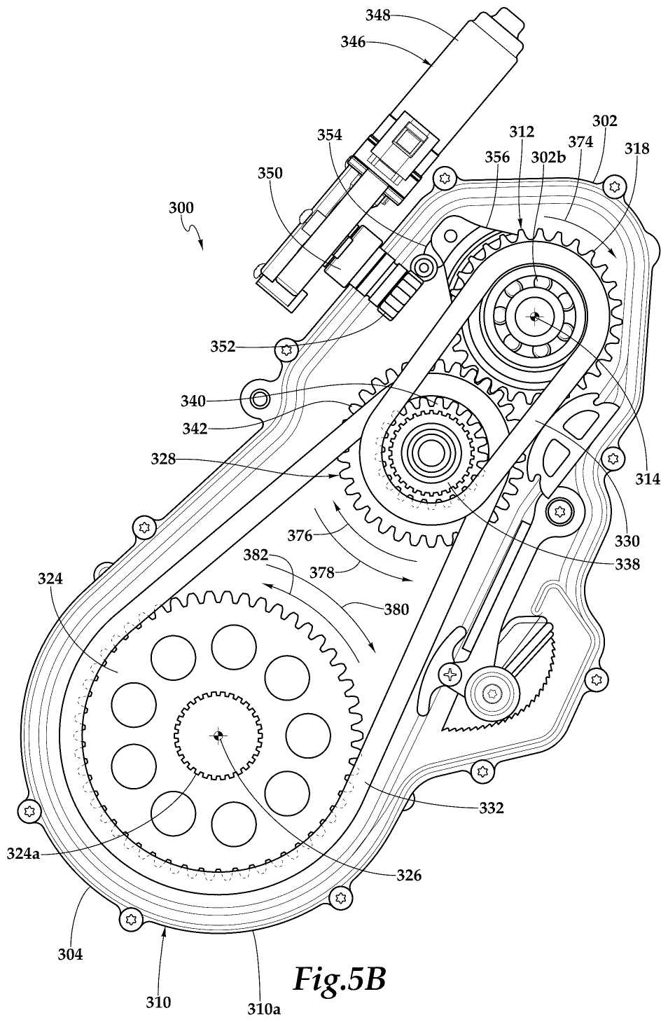

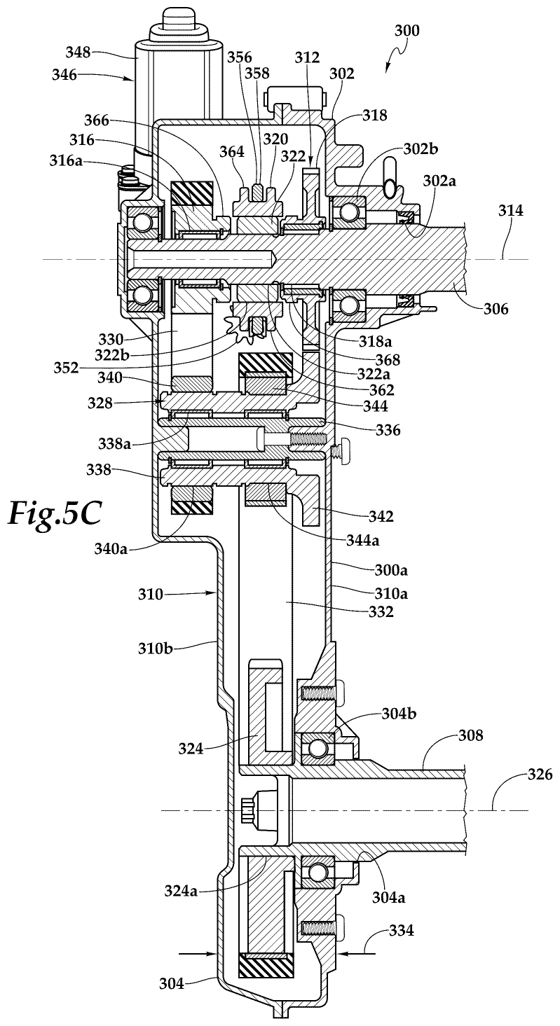

Referring to FIGS. 5A-5C in the drawings, a drop case assembly for a snowmobile is schematically illustrated and generally designated 300. Drop case assembly 300 is an example of drop case assembly 104 in FIGS. 2A-2C and 3. FIG. 5C is a cross-sectional view of drop case assembly 104 in FIG. 2B taken along line 5C-5C. Drop case assembly 300 includes an upper input section 302 defining an input socket 302a and a lower output section 304 defining an output socket 304a. Input socket 302a and output socket 304a are both located on inboard side 300a of drop case assembly 300. Input socket 302a receives and secures one end of gearbox input shaft 306, which is rotatably coupled to drop case assembly 300 via bearings 302b. Drop case assembly 300 receives rotational energy from gearbox input shaft 306, which may in turn receive rotational energy from an engine or other prime mover. Output socket 304a receives and secures one end of track driveshaft 308, which is rotatably coupled to drop case assembly 300 via bearings 304b. Track driveshaft 308 transfers rotational energy to the drive track of the snowmobile, providing propulsion thereto. Drop case assembly 300 has a cover 310 to protect components therein. Cover 310 includes an inboard shell 310a, which mates with an outboard shell 310b. Outboard shell 310b of cover 310 has been removed in FIGS. 5A and 5B to illustrate components inside of drop case assembly 300. Upper input section 302 of drop case assembly 300 houses an input gear assembly 312 coupled to gearbox input shaft 306. Input gear assembly 312 and gearbox input shaft 306 have a common input axis, or driveline, 314. Input gear assembly 312 includes a forward input pulley 316 rotatably coupled to gearbox input shaft 306 via bearing 316a and a reverse input gear 318 rotatably coupled to gearbox input shaft 306 via bearing 318a. Reverse input gear 318 is inboard of forward input pulley 316.

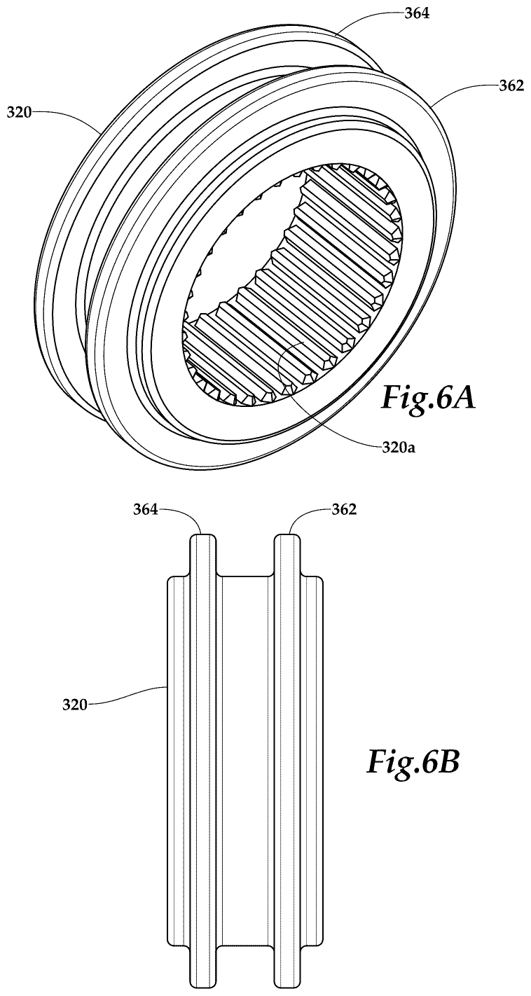

Referring additionally to FIGS. 6A-6B in the drawings, interposed between forward input pulley 316 and reverse input gear 318 is an input selector collar 320, which is coupled to gearbox input shaft 306 via a spacer 322. Spacer 322 has an inner spline that forms a splined connection 322a with an outer spline on the segment of gearbox input shaft 306 between forward input pulley 316 and reverse input gear 318. Input selector collar 320 has an inner spline 320a that mates with an outer spline of spacer 322 to form a slidable splined connection 322b between input selector collar 320 and spacer 322 such that both input selector collar 320 and spacer 322 rotate with gearbox input shaft 306. As described herein, input selector collar 320 slides axially along common input axis 314 into various positions to switch drop case assembly 300 between a forward mode and a reverse mode. In FIG. 5C, input selector collar 320 is in a neutral position that is disengaged from both forward input pulley 316 and reverse input gear 318. Lower output section 304 of drop case assembly 300 includes an output pulley 324 coupled to track driveshaft 308 via a splined connection 324a such that output pulley 324 rotates with track driveshaft 308 and defines a common output axis 326 therewith.

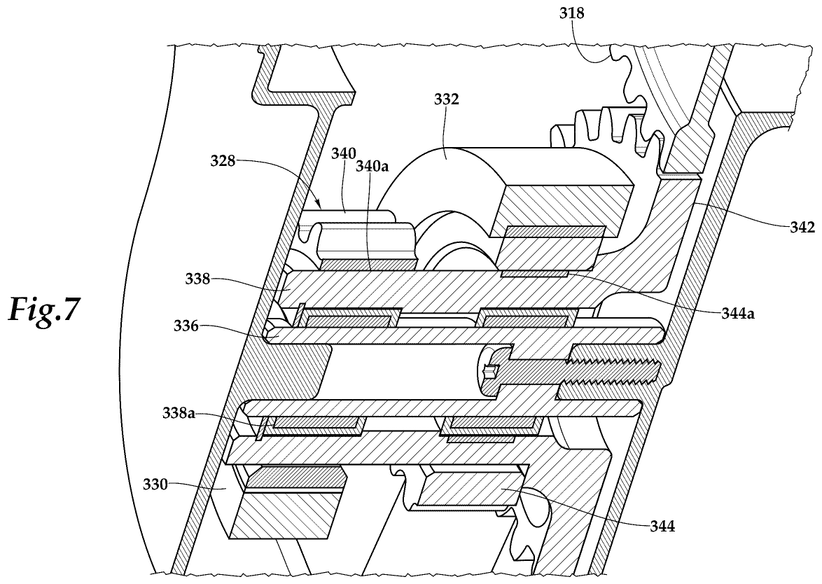

Referring additionally to FIG. 7 in the drawings, interposed between input gear assembly 312 and output pulley 324 is an idler assembly 328. An upper chain 330 located in upper input section 302 of drop case assembly 300 couples input gear assembly 312 to idler assembly 328 and an output chain 332 located in lower output section 304 of drop case assembly 300 couples output pulley 324 to idler assembly 328. Thus, upper input section 302 and lower output section 304 each house a single chain that extends to idler assembly 328, where chains 330, 332 overlap. In contrast to the lower section of chain drive assembly 200 in FIGS. 4A-4C, which includes side-by-side forward and reverse chains 220, 222 extending to bottom forward and reverse gears 210, 212, lower output section 304 of drop case assembly 300 houses only a single chain to reduce thickness 334 of lower output section 304. The thinner form factor of lower output section 304 allows space for adjacent components of the snowmobile such as toe stop 132 in FIG. 3. Chains 330, 332 may be chains or belts, and may be made from metal, metal alloy, polymeric materials, fiber reinforced polymer composites and/or combinations thereof.

Idler assembly 328 includes a post 336 and a reversible idler shaft 338 rotatably coupled to post 336 via bearings 338a. Idler assembly 328 includes a forward mode pulley 340 coupled to the outboard end of idler shaft 338 via a splined connection 340a. In the illustrated embodiment, forward mode pulley 340 and idler shaft 338 are separate components coupled to one another, although in other embodiments forward mode pulley 340 and idler shaft 338 may form an integral component. Forward mode pulley 340 is coupled to forward input pulley 316 of input gear assembly 312 via chain 330 such that idler shaft 338, forward mode pulley 340 and forward input pulley 316 rotate in the same rotational direction synchronously. The inboard end of idler shaft 328 includes a reverse mode gear 342 meshed with reverse input gear 318 of input gear assembly 312 such that idler shaft 338 and reverse input gear 318 rotate in opposite rotational directions synchronously. In the illustrated embodiment, reverse mode gear 342 is integral with idler shaft 338, although in other embodiments reverse mode gear 342 and idler shaft 338 may be separate components coupled to one another via a splined connection. Idler assembly 328 also includes an idler output pulley 344 interposed between forward mode pulley 340 and reverse mode gear 342. Idler output pulley 344 is coupled to idler shaft 338 via a splined connection 344a. In the illustrated embodiment, idler output pulley 344 and idler shaft 338 are separate components coupled to one another, although in other embodiments idler output pulley 344 and idler shaft 338 may form an integral component. Idler output pulley 344 is coupled to output pulley 324 via output chain 332 such that idler shaft 338, idler output pulley 344 and output pulley 324 rotate in the same rotational direction synchronously. In this manner, output pulley 324 is coupled to input gear assembly 312 via idler shaft 338.

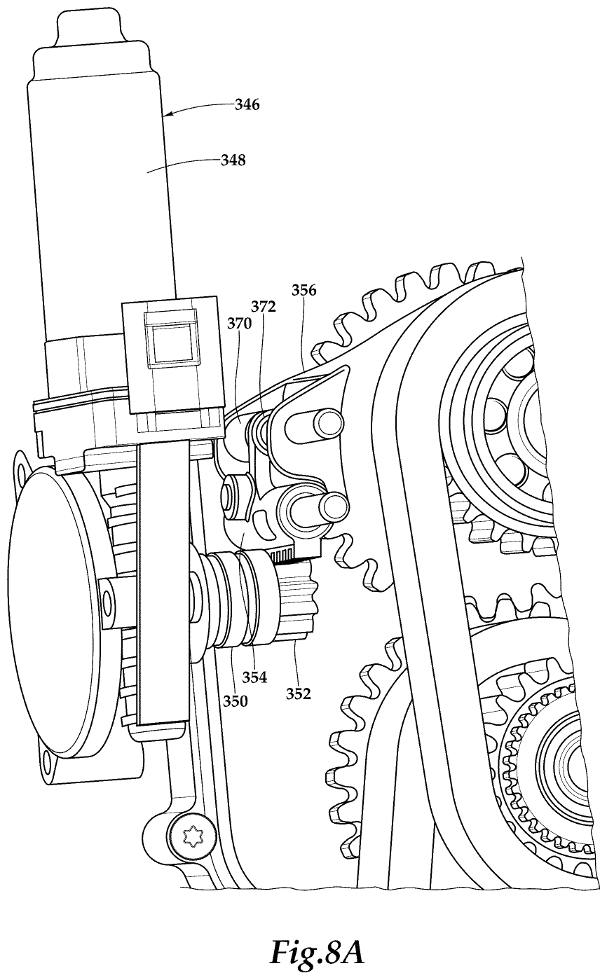

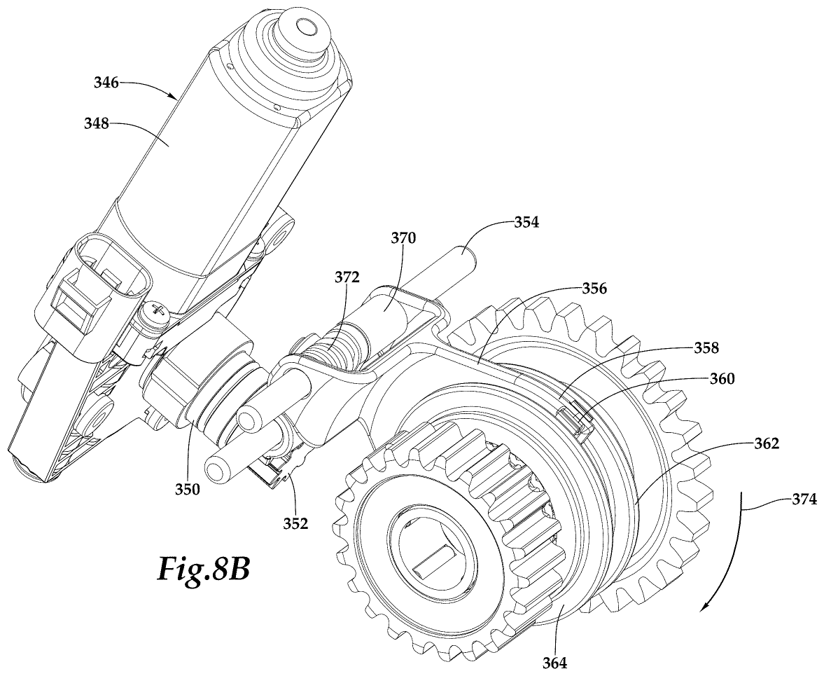

Referring additionally to FIGS. 8A-8B in the drawings, drop case assembly 300 includes an actuator assembly 346 that slides input selector collar 320 into various positions along common input axis 314. Actuator assembly 346 includes an actuator 348 that provides rotational energy to an extension piece 350 having a rotatable pinion 352 in a rack-and-pinion engagement with a shift rack 354. Actuator assembly 346 also includes a shift fork 356 interposed between shift rack 354 and input selector collar 320, with the aft end of shift fork 356 coupled to shift rack 354 and the forward end of shift fork 356 coupled to input selector collar 320. Shift fork 356 bifurcates into a pair of tines 358 that partially wrap around input selector collar 320. Because input selector collar 320 rotates with gearbox input shaft 306 while shift fork 356 does not rotate, each tine 358 of shift fork 356 includes one or more wear-resistant pads 360 at the interface with input selector collar 320. Pads 360 may be polymer pads, Vespel® pads or any other type of wear-resistant pad that reduces friction and wear between shift fork 356 and input selector collar 320. The outer surface of input selector collar 320 defines inboard and outboard positioning ridges 362, 364, between which tines 358 of shift fork 356 are interposed. Positioning ridges 362, 364 provide surfaces against which tines 358 of shift fork 356 may push to move input selector collar 320 axially along common input axis 314. While in the illustrated embodiment shift fork 356 includes a pair of tines 358 that partially wrap around input selector collar 320, in other embodiments shift fork 356 may include a ring that completely wraps around input selector collar 320 or may alternatively include a single tine that is interposed between positioning ridges 362, 364.

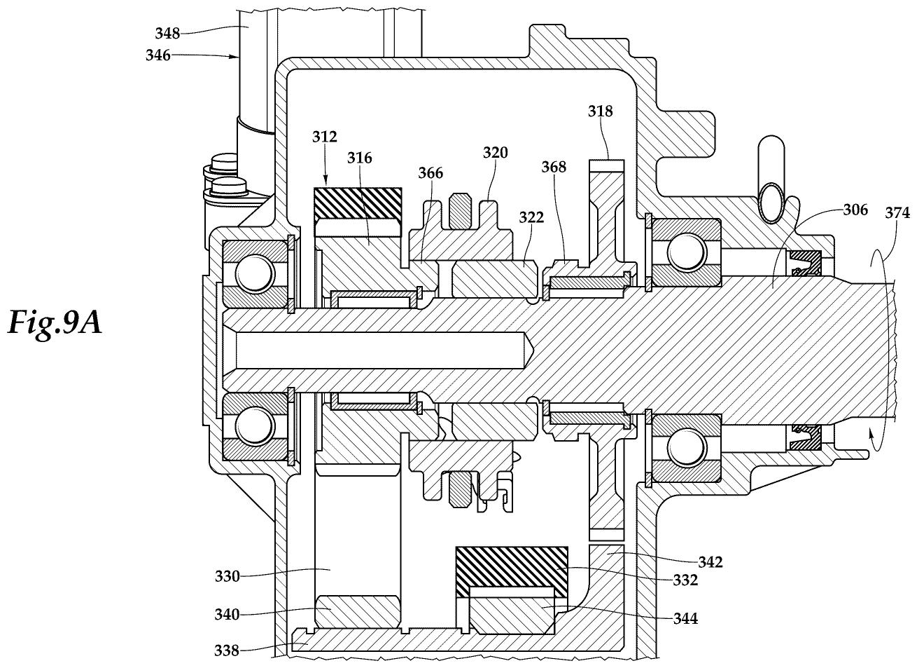

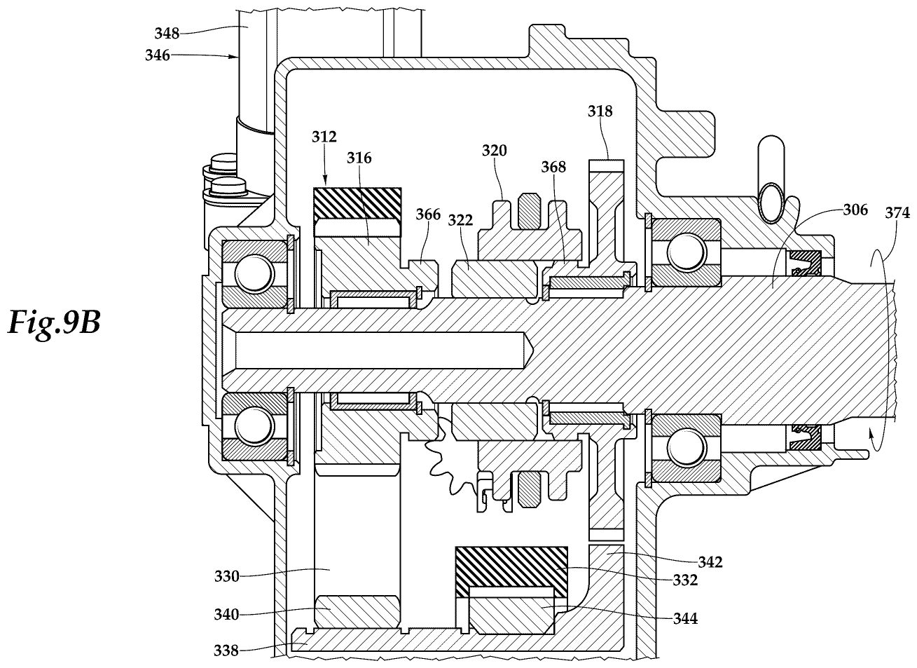

Referring additionally to FIGS. 9A-9B in the drawings, the forward mode and reverse mode positions of input selector collar 320 of input gear assembly 312 are shown in greater detail. In FIG. 9A, actuator assembly 346 has moved input selector collar 320 into the forward mode position. In FIG. 9B, actuator assembly 346 has moved input selector collar 320 into the reverse mode position, which is inboard of the forward mode position. FIG. 5C shows input selector collar 320 in the neutral position between the forward mode and reverse mode positions. In the neutral position, input selector collar 320 is disengaged from both forward input pulley 316 and reverse input gear 318. The side of forward input pulley 316 that faces input selector collar 320 defines a collar receiving spline 366, which acts as a ledge that engages input selector collar 320 in the forward mode position shown in FIG. 9A. Similarly, the side of reverse input gear 318 that faces input selector collar 320 defines a collar receiving spline 368, which acts as a ledge that engages input selector collar 320 in the reverse mode position shown in FIG. 9B. Spacer 322 acts as an offset feature that brings input selector collar 320 to the same level or circumference as collar receiving splines 366, 368, allowing for input selector collar 320 to slide into splined engagement therewith. While spacer 322 and gearbox input shaft 306 are shown as separate components in the illustrated embodiment, in other embodiments spacer 322 may be integral with gearbox input shaft 306. Shift rack 354 of actuator assembly 346 includes a spacer 370 and a spring 372 that helps to ensure that inner spline 320a of input selector collar 320 meshes with collar receiving splines 366, 368 of forward input pulley 316 and reverse input gear 318 without causing a hard stop of actuator 348 in case of a spline mismatch.

In the illustrated embodiment, gearbox input shaft 306 rotates in only a single rotational direction 374 as best seen in FIG. 5B. Additionally, because gearbox input shaft 306, spacer 322 and input selector collar 320 are splined to one another, gearbox input shaft 306, spacer 322 and input selector collar 320 rotate in the same rotational direction 374. In the forward mode of drop case assembly 300 shown in FIG. 9A, actuator assembly 346 moves input selector collar 320 outboard into the forward mode position, in which input selector collar 320 engages with collar receiving spline 366 of forward input pulley 316. In the forward mode position, input selector collar 320 bridges spacer 322 and collar receiving spline 366 of forward input pulley 316 to transfer rotational energy from gearbox input shaft 306 to forward input pulley 316 such that forward input pulley 316 rotates in the same rotational direction 374 as gearbox input shaft 306, spacer 322 and input selector collar 320. Idler shaft 338 is reversibly rotatable in either rotational direction 376 or rotational direction 378 responsive to the position of input selector collar 320. Rotational direction 374 of forward input pulley 316 may be considered the same rotational direction as rotational direction 376 since both rotational directions 374, 376 are clockwise as seen from the perspective of FIG. 5B. Because forward input pulley 316 is connected to forward mode pulley 340 via chain 330, the rotation of forward input pulley 316 in rotational direction 374 causes idler shaft 338 to rotate in rotational direction 376, which in turn causes idler output pulley 344 to rotate in rotational direction 376. Similar to idler shaft 338, output pulley 324 is reversibly rotatable in either rotational direction 380 or rotational direction 382 responsive to the position of input selector collar 320. Rotational direction 380 of output pulley 324 may be considered the same rotational direction as rotational directions 374, 376 since rotational directions 374, 376, 380 are clockwise as seen from the perspective of FIG. 5B. Because idler output pulley 344 is connected to output pulley 324 via output chain 332, the rotation of idler output pulley 344 in rotational direction 376 causes output pulley 324 to rotate in rotational direction 380, which in turn rotates track driveshaft 308 in rotational direction 380 to move the snowmobile in the forward direction. Thus, in the forward mode position of input selector collar 320 shown in FIG. 9A, drop case assembly 300 forms a forward geartrain that includes rotating components in the following sequence: (1) spacer 322, (2) input selector collar 320, (3) forward input pulley 316, (4) chain 330, (5) forward mode pulley 340, (6) idler shaft 338, (7) idler output pulley 344, (8) output chain 332 then (9) output pulley 324, each of which rotate in the same clockwise rotational direction 374, 376, 380 synchronously as seen from the perspective of FIG. 5B. In the forward mode, gearbox input shaft 306 and track driveshaft 308 also rotate in the same clockwise rotational direction as the other components of the forward geartrain.

In the reverse mode of drop case assembly 300 shown in FIG. 9B, actuator assembly 346 moves input selector collar 320 inboard into the reverse mode position, in which input selector collar 320 engages with collar receiving spline 368 of reverse input gear 318. In the reverse mode position, input selector collar 320 bridges spacer 322 and collar receiving spline 368 of reverse input gear 318 to transfer rotational energy from gearbox input shaft 306 to reverse input gear 318 such that reverse input gear 318 rotates in the same rotational direction 374 as gearbox input shaft 306, spacer 322 and input selector collar 320. Reverse input gear 318 is meshed with reverse mode gear 342 of idler shaft 338, causing idler shaft 338 to rotate in the opposite rotational direction 378 as gearbox input shaft 306, reverse input gear 318, spacer 322 and input selector collar 320. The rotation of idler shaft 338 in rotational direction 378 causes idler output pulley 344 to rotate in rotational direction 378. Because idler output pulley 344 is connected to output pulley 324 via output chain 332, the rotation of idler output pulley 344 in rotational direction 378 causes output pulley 324 to rotate in rotational direction 382, which in turn rotates track driveshaft in rotational direction 382 to move the snowmobile in the backward direction. Thus, in the reverse mode position of input selector collar 320 shown in FIG. 9B, drop case assembly 300 forms a reverse geartrain that includes rotating components in the following sequence: (1) spacer 322, (2) input selector collar 320, (3) reverse input gear 318, (4) reverse mode gear 342 of idler shaft 338, (5) idler output pulley 344, (6) output chain 332 then (7) output pulley 324. In the reverse mode, gearbox input shaft 306, spacer 322, input selector collar 320 and reverse input gear 318 each rotate in the same clockwise rotational direction 374 synchronously as seen from the perspective of FIG. 5B. Reverse mode gear 342 of idler shaft 338, idler output pulley 344, output chain 332, output pulley 324 and track driveshaft 308, however, rotate in the counterclockwise rotational direction 378, 382 synchronously as seen from the perspective of FIG. 5B, which is opposite from the clockwise rotational direction 374 of gearbox input shaft 306, spacer 322, input selector collar 320 and reverse input gear 318. Drop case assembly 300 benefits from having a neutral position of input selector collar 320 between the forward and reverse mode positions in that the neutral position helps to ensure that inner spline 320a of input selector collar 320 meshes with collar receiving splines 366, 368 of forward input pulley 316 and reverse input gear 318 when sliding along common input axis 314. By utilizing a single reversible output pulley 324 driven by a single output chain 332, lower output section 304 of drop case assembly 300 does not require stacked pulleys or chains as in chain drive assembly 200 in FIGS. 4A-4C, thereby reducing thickness 334 of lower output section 304 to spatially accommodate other components of the snowmobile such as toe stop 132 in FIG. 3. Lower output section 304 of drop case assembly 300 may thus have a thickness 334 similar to or less than certain belt drives for two-stroke engines. In certain embodiments such as embodiments in which drop case assembly 300 is used in conjunction with a two-stroke engine, reverse input gear 318 may instead be a forward input pulley or gear sized differently than forward input pulley 316 to allow for different gear ratios in a low gear and high gear implementation.

The foregoing description of embodiments of the disclosure has been presented for purposes of illustration and description. It is not intended to be exhaustive or to limit the disclosure to the precise form disclosed, and modifications and variations are possible in light of the above teachings or may be acquired from practice of the disclosure. The embodiments were chosen and described in order to explain the principals of the disclosure and its practical application to enable one skilled in the art to utilize the disclosure in various embodiments and with various modifications as are suited to the particular use contemplated. For example, numerous combinations of the features disclosed herein will be apparent to persons skilled in the art including the combining of features described in different and diverse embodiments, implementations, contexts, applications and/or figures. Other substitutions, modifications, changes and omissions may be made in the design, operating conditions and arrangement of the embodiments without departing from the scope of the present disclosure. Such modifications and combinations of the illustrative embodiments as well as other embodiments will be apparent to persons skilled in the art upon reference to the description. It is, therefore, intended that the appended claims encompass any such modifications or embodiments.

What is claimed is:

1. A powertrain for a snowmobile, the powertrain comprising:
an engine;
a gearbox input shaft receiving rotational energy from the engine; and
a drop case assembly receiving rotational energy from the gearbox input shaft, the drop case assembly switchable between a forward mode and a reverse mode and comprising:
an input gear assembly coupled to the gearbox input shaft to define a common input axis therewith, the input gear assembly comprising:
a forward input pulley rotatably coupled to the gearbox input shaft;
a reverse input gear rotatably coupled to the gearbox input shaft; and
an input selector collar at least partially interposed between the forward input pulley and the reverse input gear, the input selector collar slidable along the common input axis between a plurality of positions including a forward mode position engaged with the forward input pulley to transfer rotational energy from the gearbox input shaft to the forward input pulley in the forward mode and a reverse mode position engaged with the reverse input gear to transfer rotational energy from the gearbox input shaft to the reverse input gear in the reverse mode.

2. The powertrain as recited in claim 1 wherein, the input gear assembly further comprises a spacer defining an inner spline and an outer spline, the spacer forming a splined connection with the gearbox input shaft via the inner spline of the spacer, the input selector collar forming a slidable splined connection with the spacer via the outer spline of the spacer.

3. The powertrain as recited in claim 2 wherein, the input selector collar bridges the spacer and the forward input pulley in the forward mode position and bridges the spacer and the reverse input gear in the reverse mode position.

4. The powertrain as recited in claim 1 wherein, the forward input pulley has an input selector collar-facing side defining a collar receiving spline configured to engage the input selector collar in the forward mode position; and
wherein, the reverse input gear has an input selector collar-facing side defining a collar receiving spline configured to engage the input selector collar in the reverse mode position.

5. The powertrain as recited in claim 1 wherein, the plurality of positions of the input selector collar includes a neutral position between the forward mode position and the reverse mode position, the input selector collar disengaged from the forward input pulley and the reverse input gear in the neutral position.

6. The powertrain as recited in claim 1 wherein, the drop case assembly further comprises an idler assembly, the idler assembly comprising:
a post; and
a reversible idler shaft rotatably coupled to the post, the idler shaft reversibly rotatable in a first rotational direction and a second rotational direction opposite of the first rotational direction responsive to the position of the input selector collar.

7. The powertrain as recited in claim 6 wherein, the idler assembly comprises a forward mode pulley coupled to the forward input pulley of the input gear assembly via a chain such that the idler shaft and the forward input pulley rotate in the same rotational direction synchronously, the idler shaft rotating in the first rotational direction responsive to the input selector collar in the forward mode position.

8. The powertrain as recited in claim 6 wherein, the idler shaft comprises a reverse mode gear meshed with the reverse input gear of the input gear assembly such that the idler shaft and the reverse mode gear rotate in opposite rotational directions synchronously, the idler shaft rotating in the second rotational direction responsive to the input selector collar in the reverse mode position.

9. The powertrain as recited in claim 6 wherein, the idler assembly comprises an idler output pulley; and
wherein, the drop case assembly further comprises a reversible output pulley coupled to the idler output pulley via an output chain such that the output pulley and the idler shaft rotate in the same rotational direction synchronously, the output pulley reversibly rotatable in a first rotational direction and a second rotational direction opposite of the first rotational direction responsive to the position of the input selector collar.

10. The powertrain as recited in claim 9 further comprising a track driveshaft, the output pulley coupled to the track driveshaft to define a common output axis therewith.

11. The powertrain as recited in claim 9 wherein, the output pulley is coupled to the input gear assembly via the idler shaft.

12. The powertrain as recited in claim 9 wherein, the input gear assembly is positioned above the output pulley and the idler assembly is interposed between the input gear assembly and the output pulley.

13. The powertrain as recited in claim 9 wherein, in the forward mode position of the input selector collar, the drop case assembly forms a forward geartrain comprising components in the following sequence: (1) the input selector collar, (2) the forward input pulley, (3) the idler shaft then (4) the output pulley.

14. The powertrain as recited in claim 13 wherein, in the forward mode position of the input selector collar, the gearbox input shaft, the input selector collar, the forward input pulley, the idler shaft and the output pulley rotate in the same rotational direction synchronously to move the snowmobile in a forward direction.

15. The powertrain as recited in claim 9 wherein, in the reverse mode position of the input selector collar, the drop case assembly forms a reverse geartrain comprising components in the following sequence: (1) the input selector collar, (2) the reverse input gear, (3) the idler shaft then (4) the output pulley.

16. The powertrain as recited in claim 15 wherein, in the reverse mode position of the input selector collar, the gearbox input shaft, the input selector collar and the reverse input gear rotate in a first rotational direction synchronously and the idler shaft and the output pulley rotate in a second rotational direction synchronously to move the snowmobile in a reverse direction, the first rotational direction opposite of the second rotational direction.

17. A snowmobile comprising:
a frame assembly; and
a powertrain coupled to the frame assembly, the powertrain comprising:
an engine;
a gearbox input shaft receiving rotational energy from the engine; and
a drop case assembly receiving rotational energy from the gearbox input shaft, the drop case assembly switchable between a forward mode and a reverse mode and comprising:
an input gear assembly coupled to the gearbox input shaft to define a common input axis therewith, the input gear assembly comprising:
a forward input pulley rotatably coupled to the gearbox input shaft;
a reverse input gear rotatably coupled to the gearbox input shaft; and
an input selector collar at least partially interposed between the forward input pulley and the reverse input gear, the input selector collar slidable along the common input axis between a plurality of positions including a forward mode position engaged with the forward input pulley to transfer rotational energy from the gearbox input shaft to the forward input pulley in the forward mode and a reverse mode position engaged with the reverse input gear to transfer rotational energy from the gearbox input shaft to the reverse input gear in the reverse mode.

18. The snowmobile as recited in claim 17 wherein, the reverse input gear is inboard of the forward input pulley and the reverse mode position of the input selector collar is inboard of the forward mode position of the input selector collar.

19. The snowmobile as recited in claim 17 wherein, the drop case assembly further comprises an actuator assembly including a shift fork coupled to the input selector collar, the actuator assembly configured to slide the input selector collar along the common input axis between the plurality of positions.

20. The snowmobile as recited in claim 19 wherein, the input selector collar has an outer surface defining first and second positioning ridges, the shift fork including one or more tines interposed between the first and second positioning ridges.
